(19) United States
(12) Patent Application Publication
(10) Pub. No.: US 2018/0243836 A1
(43) Pub. Date: Aug. 30, 2018

(54) CUTTING TOOL

(71) Applicant: Kennametal Inc., Latrobe, PA (US)

(72) Inventors: Jüergen Bär, Furth (DE); Markus Heinloth, Postbauer-Heng (DE)

(21) Appl. No.: 15/903,847

(22) Filed: Feb. 23, 2018

(30) Foreign Application Priority Data
Feb. 27, 2017 (DE) 102017103978.3

(51) Int. Cl. B23B 27/14; B23B 51/10; B23G 1/44

(52) U.S. Cl. CPC B23B 27/14; B23B 51/101; B23D 37/00; B23D 2277/2471; B23D 2277/2421; B23G 1/44

(57) ABSTRACT

A cutting tool for metal is described that comprises a main body produced from metal, wherein the main body is reinforced with a reinforcing material. The cutting tool can be a milling tool, a turning tool, a drilling tool, a thread cutting tool, a broaching tool, a turn broaching tool, a reaming tool, a deburring tool, a combination tool and/or a multifunctional tool.

### RELATED APPLICATION DATA

The present application claims priority pursuant to 35 U.S.C. § 119(a) to German Patent Application Number DE102017103978.3 filed Feb. 27, 2017 which is incorporated herein by reference in its entirety.

### FIELD

The invention relates to a cutting tool for metal, with a main body produced from metal.

### BACKGROUND

Such cutting tools are known from the prior art and are used for a wide variety of applications. In particular, they are frequently used for machining metal components. One example of a field of application is the automobile industry.

In designing cutting tools, a compromise between the mechanical properties, in particular rigidity, and the tool weight must always be found. In this regard, large and heavy tools are generally difficult to handle, for example can only be moved with equipment. In contrast, very light tools frequently only possess a slight rigidity.

### SUMMARY

The object of the invention is to further improve cutting tools of the aforementioned kind. In doing so, especially light cutting tools that also have a high rigidity are to be created.

The object is achieved by a cutting tool of the aforementioned kind in which the main body is reinforced with a reinforcing material. In doing so, the reinforcing material generally has a lower density than the metal from which the main body is produced. At the same time, the rigidity of the main body can be increased by means of the reinforcing material. Such a cutting tool is consequently lighter overall than cutting tools known from the prior art. At the same time, the rigidity remains basically the same or is even increased in comparison to the prior art. This can even be achieved when the rigidity of the reinforcing material is less per se than the rigidity of the main body material. For this, the reinforcing material must be arranged in a region of the cutting tool in which the lesser rigidity of the reinforcing material satisfies or exceeds the rigidity requirements. Such tools are easy to handle given the low weight. For example, they can be moved by hand. A crane or other equipment for maneuvering the cutting tool can thus, for example, be omitted. These advantages can, for example, be manifested particularly in cutting tools that are specially designed for processing crankshafts of internal combustion engines.

The basic concept of the invention is to adapt the mechanical properties of the cutting tool as precisely as possible to the required mechanical properties by using two different materials and to thereby save weight overall. In particular, reinforcing material that has a lesser density than the main body material is to be used at those locations at which the mechanical properties of the reinforcing material are closer to the required mechanical properties. This renders the cutting tool lighter overall.

According to a preferred embodiment, the reinforcing material is a fiber material or an aluminum material, in particular a carbon fiber material, a glass fiber material, a natural fiber material, a ceramic fiber material, and/or an aramid fiber material. Other suitable fiber materials can also be used. Given the aforementioned low density of the fiber or aluminum materials, a particularly light cutting tool that is simultaneously sufficiently rigid can accordingly be realized. This holds true in particular in comparison to a weight-optimized pure steel tool from the prior art where starting at a certain limit, a weight reduction is always associated with a reduction in rigidity. The weight reduction potential of such tools is therefore substantially exhausted.

Advantageously, the main body is produced from a steel material. The main body can thus be produced easily and economically using standard methods.

In a development, at least one functional surface of the cutting tool is on the main body, wherein preferably all the functional surfaces are on the main body. The functional surfaces thus do not differ from the functional surfaces of known cutting tools so that a known modularity of the cutting tool is retained, for example with regard to potential add-on parts or cutting inserts. The same holds true with regard to mounting cutting tools in machine tools.

In this regard, the functional surface can be a contact surface for a machine tool, or a seat for a cutting insert, in particular for an indexable insert. A cutting tool according to the invention can therefore be easily used in known machine tools. Likewise, known cutting inserts and/or indexable inserts can be used in conjunction with such cutting tools.

Preferably, the functional surface does not comprise any reinforcing material, in particular any fiber material. The functional surfaces can therefore be processed using known and proven production methods. In doing so, the conventional dimensional, shape and position tolerances as well as the known surface qualities can be observed.

The cutting tool can comprise one or more cutting inserts, in particular an indexable insert, where the cutting inserts are each attached to a cutting insert seat arranged on the main body. A cutting tool can thereby be created with high performance in cutting operations, in particular machining operations. Moreover, such a cutting tool has a long service life.

In one embodiment, the reinforcing material is applied to the outside of the main body and attached thereto. This renders the production of the cutting tool particularly easy and economical. For example, first the main body can be produced, and then the fiber material can be applied. In the event that an aluminum material is used as the reinforcing material, the main body and a reinforcing part made of aluminum can be produced first. Then, the main body and the reinforcing part can be connected to each other, for example by screwing.

Moreover, in the production of a tool according to the invention, the main body can be produced from metal using known methods. This main body constitutes a reduced or minimized main body as it were in comparison to conventional cutting tools. For the fiber material, geometries that facilitate its arrangement can be provided on the main body. For example, such geometries can be recesses filled with fiber material. For a reinforcing part made of aluminum, corresponding seating geometries can also be provided that facilitate the positioning of the reinforcing part relative to the main body.

The main body of the cutting tool can have the shape of an annular disk to which, on at least one of its faces, the reinforcing material is attached. Cutting tools with this shape are, for example, used for machining crankshafts. In doing so, an inner or outer casing surface of the annular disk is machined. This achieves that the known functionalities of such a cutting tool are unrestricted by reinforcement with a fiber or aluminum material.

Advantageously, the cutting tool weighs less than 20 kg, preferably less than 15 kg. Such cutting tools can be moved manually and in particular arranged manually in machine tools. Tool changes are therefore comparatively easy. This holds true in particular in comparison to a tool change for which a crane is required.

The rigidity of the cutting tool can substantially correspond to the rigidity of a functionally equivalent unreinforced tool with an identical outer geometry, wherein the unreinforced tool is preferably produced from steel. The advantage of the cutting tool according to the invention being lighter is thus not achieved at the cost of rigidity. Accordingly, a cutting tool is created with a machining performance that is equal to or greater than the performance of a functionally equivalent unreinforced tool. This is because reduced centrifugal and inertial forces act on the reinforced cutting tool due to the reduced weight so that it can be moved more dynamically in comparison to known tools. Moreover, it can be moved at higher speeds and/or rotational speeds with an unchanged machine tool drive.

The cutting tool can be a milling tool, a turning tool, a drilling tool, a thread cutting tool, a broaching tool, a turn broaching tool, a reaming tool or a deburring tool. The cutting tool can thus to be used for nearly all types of machining. In this regard, the cutting tool can in particular be an internal or external milling cutter for processing crankshafts. Moreover in particular, the cutting tool can be used for deburring boreholes in main bearings and oil lines.

Furthermore, the cutting tool can be a combination tool and/or a multifunctional tool. Given the lighter design of the cutting tool overall, it is therefore possible to combine functions in one tool that could not be combined in the prior art, in particular for reasons of weight. Cutting tools with a greater functional range can therefore be created.

The reinforcing material can run in a closed ring around the rotational axis of the cutting tool. If the reinforcing material is an aluminum material, it can for example be in the form of a ring component. In the event that the reinforcing material is a fiber material, comparatively long fibers or fiber strands can be used. Accordingly, particularly favorable mechanical properties, such as rigidities, can be achieved in conjunction with a low weight. Furthermore, the cutting tool is reinforced symmetrically. By means of this symmetry in conjunction with the low weight of the cutting tool, particularly high rotational speeds and hence particularly high machining performances can be achieved.

The reinforcing material can have the shape of an annular disk and preferably be designed as a reinforcing part that is separate from the main body and connected to the main body. The reinforcing part can therefore be produced from an aluminum material or a fiber material in parallel to the main body. In a subsequent step, the main body is connected to the reinforcing part. In this way, an efficient cutting tool production results.

### BRIEF DESCRIPTION OF THE DRAWINGS

The invention will be explained below with reference to an exemplary embodiment that is portrayed in the accompanying drawings. In the figures:

FIG. 1 shows a perspective view of a cutting tool according to the invention according to a first embodiment,

FIG. 2 shows a detailed view II of the cutting tool of FIG. 1;

FIG. 3 shows a perspective view of a section of a cutting tool according to the invention according to a second embodiment, and

FIG. 4 shows a plan view of the reinforcing part of FIG. 3.

### DETAILED DESCRIPTION

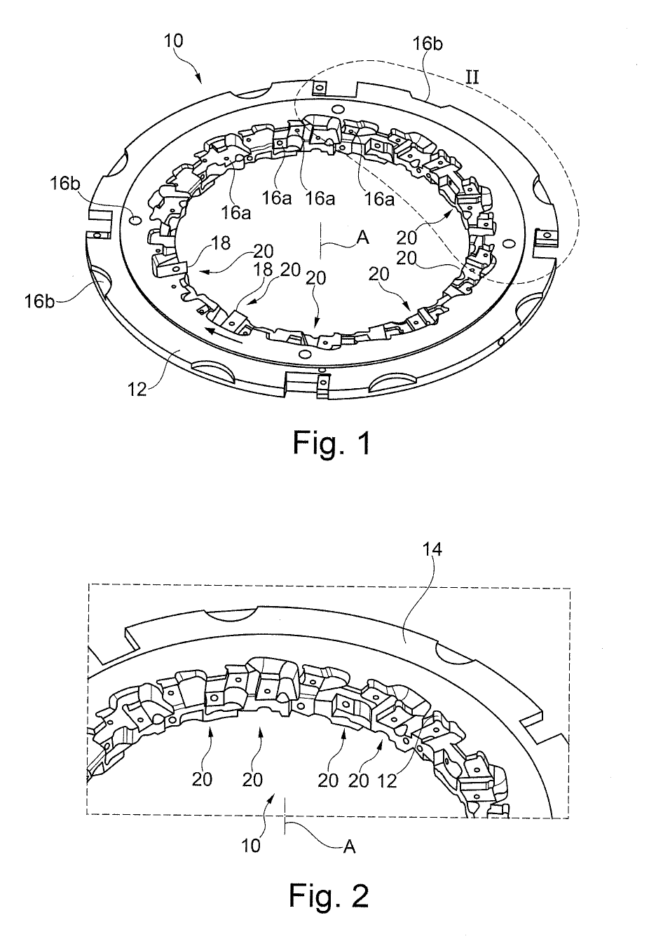

FIG. 1 shows a cutting tool 10 with a main body 12 produced from metal.

This is a combination tool for combined face and circumference processing, specially designed for processing crankshafts of internal combustion engines.

Likewise, the cutting tool 10 can however also be a milling tool, a turning tool, a drilling tool, a thread cutting tool, a broaching tool, a turn broaching tool, a reaming tool, a deburring tool and/or a multifunctional tool.

The main body 12 of the cutting tool 10 is reinforced with a reinforcing material 14 that is a fiber material in the described embodiment (see FIG. 2).

In this case, the main body 12 has the shape of an annular disk to a face of which the reinforcing material 14 is attached. The other face is not visible. Of course, the reinforcing material 14 can also be attached thereto.

The reinforcing material 14 is applied to the outside of the main body 12 and attached thereto.

In the portrayed exemplary embodiment, the reinforcing material 14 runs in a closed ring around a rotational axis A of the cutting tool 10.

The main body 12 is produced from a steel material, and the reinforcing material 14 is a carbon fiber material.

The reinforcing material 14 can alternatively be a glass fiber material, a natural fiber material, a ceramic fiber material and/or an aramid fiber material. Likewise, the main body 12 can be produced from any other metal.

The main body 12 comprises first functional surfaces 16a that are designed as a seat for a cutting insert 18, in this case indexable insert seats.

Moreover, the main body 12 comprises second functional surfaces 16b that are designed as contact surfaces in the broadest sense for a machine tool (not shown).

The functional surfaces 16a, 16b do not comprise any reinforcing material 14.

In the portrayed cutting tool 10, two cutting inserts 18, which are indexable inserts in the portrayed embodiment, are provided by way of example.

The cutting inserts 18 are attached to cutting insert seats 20 arranged on the main body 12. However, for reasons of clarity, not all cutting insert seats 20 are provided with cutting inserts 18.

In the portrayed embodiment, the cutting tool 10 weighs less than 15 kg and has a rigidity that substantially corresponds to a rigidity of a functionally equivalent, unreinforced tool that has an identical outer geometry and is produced entirely from steel.

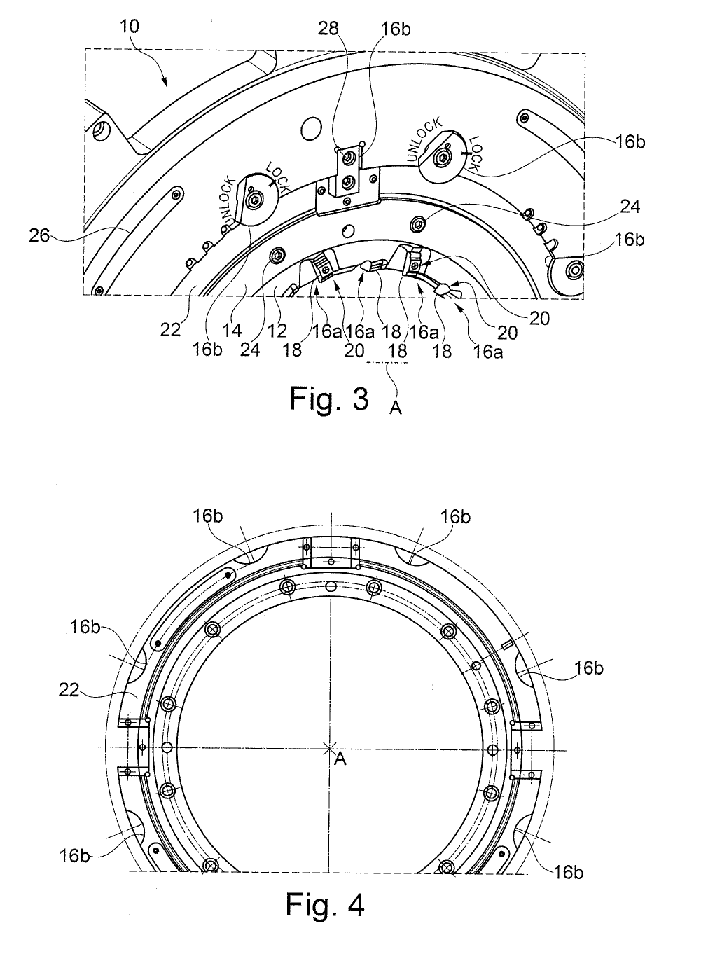

FIGS. 3 and 4 show a second embodiment of the cutting tool 10 in which the reinforcing material 14 is an aluminum material. In the following, only the differences from the first embodiment will be addressed.

The reinforcing material 14 in this case has the shape of an annular disk and is designed as a reinforcing part 22 separate from the main body 12.

This reinforcing part is connected by screws 24 to the main body 12.

In contrast to the first embodiment, the functional surfaces 16b by means of which the cutting tool 10 is connected to a machine tool 26, only a section of which is shown, are now arranged on the reinforcing part 22.

In this context, a rotary driver 28 can also be seen, by means of which the cutting tool 10 is rotationally driven by the machine tool.

1. A cutting tool for metal with a main body produced from metal, characterized in that the main body is reinforced with a reinforcing material.

2. The cutting tool according to claim 1, characterized in that the reinforcing material is a fiber material or an aluminum material.

3. The cutting tool according to claim 1, characterized in that the main body is produced from a steel material.

4. The cutting tool according to claim 1, characterized in that at least one functional surface of the cutting tool is on the main body.

5. The cutting tool according to claim 4, characterized in that the functional surface is a contact surface for a machine tool, or a seat for a cutting insert.

6. The cutting tool according to claim 4, characterized in that the functional surface does not comprise any reinforcing material.

7. The cutting tool according to claim 1, characterized in that it comprises one or more cutting inserts, wherein the cutting inserts are each attached to a cutting insert seat arranged on the main body.

8. The cutting tool according to claim 1, characterized in that the reinforcing material is applied to the outside of the main body and attached thereto.

9. The cutting tool according to claim 1, characterized in that the main body has the shape of an annular disk that, on at least one of its faces, has the reinforcing material attached thereto.

10. The cutting tool according to claim 1, characterized in that it is a milling tool, a turning tool, a drilling tool, a thread cutting tool, a broaching tool, a turn broaching tool, a reaming tool or a deburring tool

11. The cutting tool according to claim 1, characterized in that it is a combination tool or a multifunctional tool.

12. The cutting tool according to claim 1, characterized in that the reinforcing material runs in a closed ring around a rotational axis of the cutting tool.

13. The cutting tool according to claim 12, characterized in that the reinforcing material has the shape of an annular disk.

14. The cutting tool of claim 2, characterized in that the fiber material comprises a carbon fiber material, a glass fiber material, a natural fiber material, a ceramic fiber material, an aramid fiber material or combinations thereof.

15. The cutting tool of claim 4 comprising a plurality of functional surfaces on the main body.

16. The cutting tool of claim 7, characterized in that the cutting inserts are indexable.

17. The cutting tool of claim 13, characterized in that the annular disk is separate from the main body and coupled to the main body.

18. The cutting tool of claim 5, characterized in that the cutting insert is indexable.
